(19) United States
(12) Patent Application Publication
(10) Pub. No.: US 2012/0084172 A1
(43) Pub. Date: Apr. 5, 2012

(54) SYSTEMS AND METHODS FOR OPERATING A MARKETPLACE SERVICE FOR RENEWABLE ENERGY RESOURCES

(75) Inventors: Sam H. Lee, Menlo Park, CA (US); Erik C. Smith, Menlo Park, CA (US)

(73) Assignee: Alta Energy, Inc., Menlo Park, CA (US)

(21) Appl. No.: 12/896,776

(22) Filed: Oct. 1, 2010

(51) Int. Cl. G06Q 30/00

(52) U.S. Cl. 705/26.3; 705/26.1

(57) ABSTRACT

Disclosed herein are methods and systems for operating an exchange service for renewable energy resources. In one embodiment, an exchange service, implemented on an exchange entity server, receives inputs from property entities related to assets available for installation of a renewable energy setup. The exchange server places this asset in a marketplace, allowing other provider entities to place a bid for installing the renewable energy setup at a location associated with the asset. Examples of the provider entities include a developer entity, a manufacturer entity, a financier entity, etc. In embodiments, the marketplace enables interaction among the provider entities to enable the provider entities to develop and place a composite bid for a selected asset available through the marketplace.

### FIELD

The present invention generally relates to the field setting up and operating a marketplace, including an exchange service for renewable energy resources. In embodiments, the present invention relates to methods and systems for using a marketplace model to allow key participants of power purchase agreements or other such renewable energy development models to conduct transactions.

### BACKGROUND

With the recent technological advancements and widespread research in the field of renewable sources of energy, more and more establishments have been “going green” by partially or completely switching to renewable sources of energy. For example, it is becoming increasingly common for commercial establishments to install solar panels (or other renewable energy components) on their rooftops or other relevant spaces to generate power using solar energy, thereby offsetting at least some of the high costs they pay for traditional sources of energy. However, given the steep upfront cost of materials, installation, and eventual maintenance of renewable power systems, going “green” is not a viable economic option for most establishments.

Recent trends provide a variety of business models for the development of renewable energy. One such example, a Power Purchase Agreements (PPA) model, allows such companies to go solar (or switch to other renewable sources of energy) without the need for any capital investment. While the remainder of this background discussion focuses on the PPA business model, it is emphasized that the embodiments described in this document apply to any business model used for renewable energy developments. In the context of solar power, a solar PPA is a financial arrangement in which a third-party developer owns, operates, and maintains the PV system, and a host customer agrees to site the system on its roof or elsewhere on its property and purchases the system's electric output from the solar services provider for a predetermined period. This financial arrangement allows the host customer to receive stable, and sometimes lower cost electricity, while the solar services provider or another party acquires valuable financial benefits such as tax credits and income generated from the sale of electricity to the host customer.

With this business model, the host customer buys the services produced by the PV system rather than the PV system itself. This framework is referred to as the “solar services” model, and the developers who offer solar PPAs are known as solar services providers. Solar PPA arrangements enable the host-customer to avoid many of the traditional barriers to adoption for organizations looking to install solar systems: high up-front capital costs; system performance risk; and complex design and permitting processes. In addition, solar PPA arrangements can be cash flow positive for the host customer from the day the system is commissioned.

There are several key players in the solar PPA process. A host customer (or “property entity”) agrees to have solar panels installed on its property (e.g., rooftop, parking lots, etc.), and signs a long-term contract with the solar services provider to purchase the generated power. The host property can be either owned or leased. The purchase price of the generated electricity could be at or below the retail electric rate the host customer would pay its utility service provider. Solar PPA rates can be fixed, but they often contain an annual price escalator in the range of one to five percent to account for system efficiency decreases as the system ages and inflation-related costs increases for system operation, monitoring, maintenance, and anticipated increases in the price of grid-delivered electricity. In some instances, a solar PPA is a performance-based arrangement in which the host customer pays only for what the system produces. The term length of most solar PPAs can range from six years (i.e., the time by which available tax benefits are fully realized) to as long as 25 years.

The solar services provider (or, the “developer entity”) functions as the project coordinator, arranging the financing, design, permitting, and construction of the system. The solar services provider purchases the solar panels for the project from a manufacturer (or “manufacturer entity”), who provides warranties for system equipment. The manufacturer entity may usually design the system, specify the appropriate system components, and may perform the follow-up maintenance over the life of the PV system. In some instances, the manufacturer entity may also function as a developer entity. To install the system, the developer entity might use an in-house team of installers or have a contractual relationship with an independent installer.

An investor (or, “financing entity”) provides equity financing and receives the federal and state tax benefits for which the system is eligible. Under certain circumstances, the investor and the solar services provider may together form a special purpose entity for the project to function as the legal entity that receives and distributes to the investor payments from the sale of the systems kWh output and tax benefits.

The utility serving the host customer provides an interconnection from the PV system to the grid, and continues its electric service with the host customer to cover the periods during which the system is producing less than the site's electric demand. Certain states have net metering requirements in place that provide a method of crediting customers who produce electricity on-site for generation in excess of their own electricity consumption. In most states, the utility will credit excess electricity produced from the system, although the compensation varies significantly depending on state polices.

Although the PPAs generally function as a win-win for all key players, the PPA business model has not gained immense popularity due to the several constraints, including the lack of a common transaction medium for the associated parties.

Overall, the examples herein of some prior or related systems and their associated limitations are intended to be illustrative and not exclusive. Other limitations of existing or prior systems will become apparent to those of skill in the art upon reading the following Detailed Description.

### SUMMARY OF THE DESCRIPTION

At least one embodiment relates to a method and system for operating a marketplace and an exchange service for renewable energy resources. In one embodiment, an exchange service, implemented on an exchange entity server, receives inputs from property entities related to assets available for installation of a renewable energy setup. In some instances, the exchange service collects information related to the property and initiates a prequalification process before placing the asset on an online marketplace. The exchange server places this asset in the marketplace, allowing other provider entities to place a bid for installing the renewable energy setup at a location associated with the asset. Examples of the provider entities include a developer entity, a manufacturer entity, a financier entity, etc. In embodiments, the marketplace enables interaction among the provider entities to enable the provider entities to develop and place a composite bid for a selected asset available through the marketplace.

In embodiments, the exchange service provides additional services to the various entities, including, for example, providing a dashboard service to the property entity to enable the property entity to track various goals associated with the PPA (or other renewable energy development business model) established as a result of the prior bidding process in the marketplace. Further, in some embodiments, the exchange service provides a resale service offering the developer entity and the manufacturer entity an opportunity to place solar parts (or other renewable energy setup parts) in a resale market.

Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 provides a brief, general description of a representative environment in which the invention can be implemented;

FIG. 2 illustrates a suitable setup for operating the exchange service (and corresponding marketplace service) offered through the exchange entity server;

FIG. 3 illustrates an example of a post-installation user dashboard offered by the exchange service;

FIG. 4 provides a quick snapshot of the various roles played by the exchange service to each of the entities;

FIG. 5 is a block diagram illustrating the business aspects and monetary gains associated with the exchange server entity in return for offering the exchange service;

FIG. 6 is a simplified flow diagram providing a summary of the overall services offered with respect to the exchange service; and

FIG. 7 is a high-level block diagram showing an example of the architecture for a computer system.

The headings provided herein are for convenience only and do not necessarily affect the scope or meaning of the claimed invention.

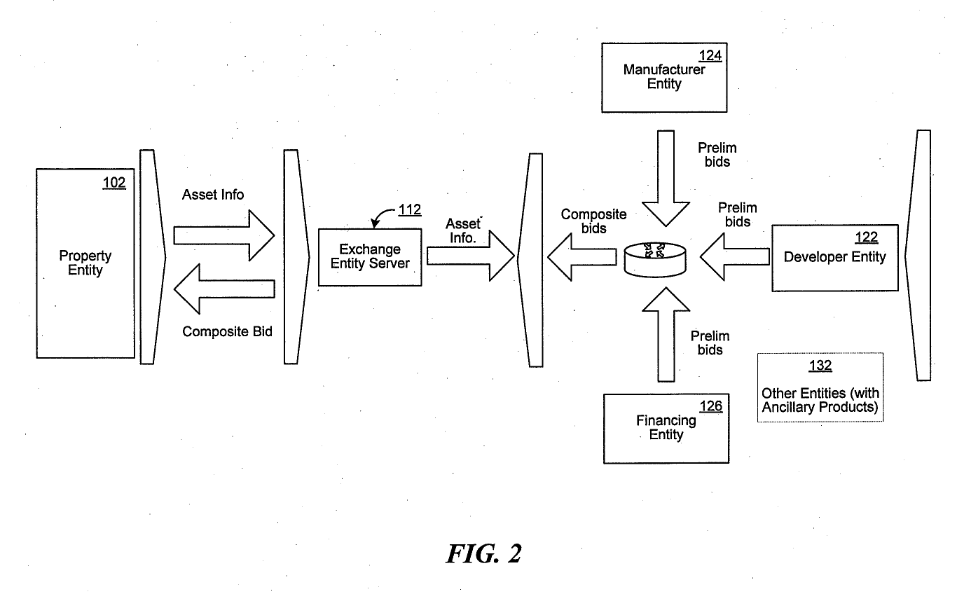

In the drawings, the same reference numbers and any acronyms identify elements or acts with the same or similar structure or functionality for ease of understanding and convenience. To easily identify the discussion of any particular element or act, the most significant digit or digits in a reference number typically refer to the Figure number in which that element is first introduced (e.g., element 204 is first introduced and discussed with respect to FIG. 2).

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

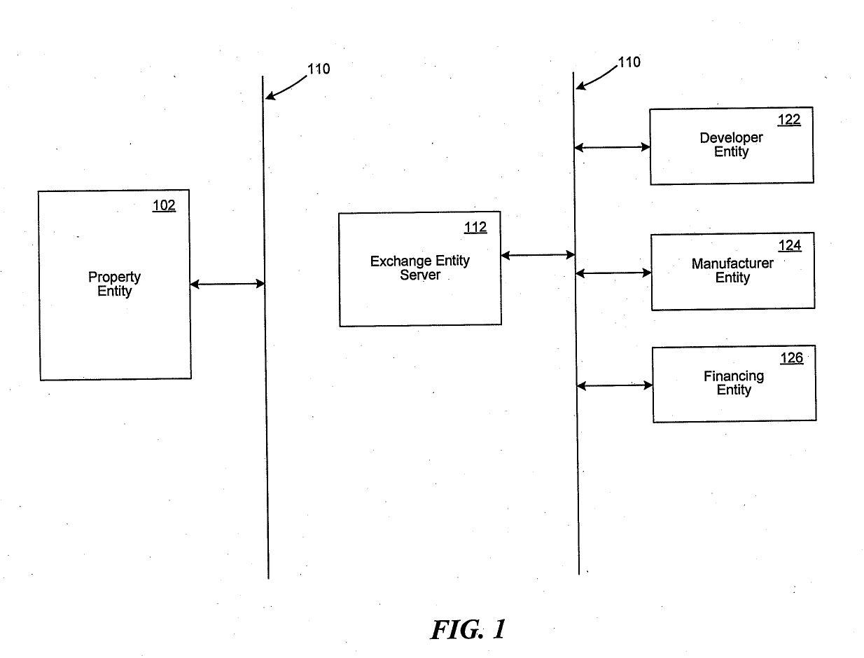

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

As illustrated in FIG. 1, an exchange entity server 112 operates an “exchange entity service” (or simply, an “exchange service”). An elaborate discussion of the exchange service is provided in detail below with reference to FIGS. 2-6. Briefly, the exchange service runs on the exchange entity server 112, allowing other entities (e.g., a property entity 102, a developer entity 122, a manufacturer entity 124, and/or a financing entity 126) to communicate and operate in a marketplace setting offered by the exchange service. As will be explained in detail further below, in embodiments, the marketplace is operated by the exchange entity server 112 and offers the property entity 102 to place assets.

In one example, the assets related to property locations owned by the property entities that are available for the installation of a renewable energy setup. As described here, the renewable energy setup may relate to any type of installation, servicing, operation, management, maintenance, or accounting of equipment that facilitates the generation of any type of renewable energy. Examples of such renewable energies include solar power, geothermal power, wind power, tidal power, hydro power, etc., as may be readily appreciated by a person of ordinary skill in the art. Corresponding examples of renewable energy setup may include any type of installation, servicing, operation, management, maintenance, or accounting of solar-cell panels, windmills, etc.

Returning to FIG. 1, the exchange entity server 112 communicates with the remaining entities, for example, by means of a network. In some instances, the network 110 is the Internet. In some instances, especially where one of the entities (e.g., the property entity 102) is a accessed through a smart phone (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

In embodiments, each of the remaining entities illustrated in FIG. 1 (e.g., the property entity 102, the developer entity 122, the manufacturer entity 124, the financing entity 126) are implemented using any type of computer setup. For example, these entities may operate as servers, allowing users to use other client terminals (e.g., a smart phone or a PC) to access the entities to in turn communicate with the exchange entity server 112. In other examples, these entities may themselves be client terminals with processing capacity to directly communicate with the exchange entity server 112. It is understood that other connection configurations, as can be contemplated by a person of ordinary skill in the art, may also be substituted with the configuration illustrated in FIG. 1.

For purpose of further illustration, it is useful to consider the techniques explained herein as applied to a solar energy setup, as described with reference to FIGS. 2-6 below. Of course, however, it should be noted that the techniques introduced here extend and are equally applicable to any other renewable energy setup that can be contemplated by a person of ordinary skill in the art (such as, e.g., geothermal energy setup, tidal energy setup, wind energy setup, etc.).

FIG. 2 illustrates an exemplary setup for operating the exchange service (and corresponding marketplace service) offered through the exchange entity server 112. In embodiments, a property owner places “assets” available for the marketplace transaction on the exchange service through the property entity 102. These assets may relate to locations of parking lots, roof tops, fields, etc., owned or otherwise controlled by the property owner over which the property owner intends to have the solar energy setup installed. As described herein, a “property owner” may relate to any entity that has an interest in the related property. This could be the owner of the property (e.g., an owner of a house, a commercial building, a parking structure, etc.), or a party leasing the property, or even a party specially acquiring an interest in the property for the particular purpose of establishing the solar energy setup. It is understood that the term “property entity” is not restricted an entity with any particular interest in the property. The inputs provided by the property entity may include a variety of details, including, for example, the geographic location of the area available for solar energy installation, type of property (e.g., rooftop, open field, etc.), area of usable property for the purpose of solar cell installation (e.g., areas covered by shade, areas covered by air ducts, etc.), preferences for the type of developer or manufacturer, preferences of expected returns or energy savings per year, etc.

Referring back to FIG. 2, the exchange service receives the property locations placed by one or more property entities and places it in a marketplace operated by the exchange service. In some examples, the exchange service directly places the property in the marketplace. In some examples, the exchange service initiates a series of background processing to ensure that the property is “qualified” for solar energy installation. This may include, for example, submitting the property information to evaluators who do a series of steps to assess the feasibility of solar energy installation. Such qualification responsibilities may be initiated and conducted by the operators of the exchange service, or may be passed on to one of the other entities. In embodiments, the exchange service may initiate a computerized aerial investigation (e.g., using satellite images of the location), may initiate a work order for physical on-site inspection of the property, etc. Accordingly, the exchange service qualifies one or more assets (that are associated with property locations submitted by the user). Also, as discussed above, in at least some embodiments, the exchange service ensures that the assets are reasonably pre-qualified for solar energy installation before placing such assets on the marketplace.

In embodiments, the assets are now available to be bid upon by one or more of the entities. As depicted in FIG. 2, the various entities (e.g., the manufacturer entity 124, the developer entity 122, and the financing entity 126) have access to the exchange service (and the corresponding marketplace offered by the exchange service) over the network 110. In some embodiments, the entities could also include other entities 132, such as entities with ancillary products (e.g., insurance services, used-part sale service agents, etc.) who may also participate in the marketplace exchange. When the assets are placed on the market, the entities are able to place bids to install the solar energy setup on a property location identified by one of the assets.

There are several means by which a “composite” bid can be returned to a user. In one embodiment, each entity places a separate bid for an asset. For example, a manufacturer entity 124, a developer entity 122, and a financing entity 126, each place a separate bid indicating an interest in a first property. Here, the exchange service operates as a matchmaker by first internally communicating the bids for the first property to each entity. In this manner, the entities have a choice on determining a partner to work with on a particular asset, determine a bid price, and place a final composite bid to be transmitted to the property entity.

In an illustrative example, consider bids placed by a first manufacturer entity, a first developer entity, and a first financing entity for an asset named XYZ. The exchange service transmits the bids placed by the first developer entity and the first financing entity to the first manufacturer entity, the bids placed by the manufacturer entity and the financing entity to the developer entity and so on. In this manner, the exchange service offers an independent forum (depicted for example as 160 in FIG. 2), independent of the bidding marketplace, for the entities to congregate and determine a final composite bid to present to the property entity 102. Such composite bids may include information related to cost of installing the energy setup, the expected energy costs the property entity 102 may expect to have over a given period of time, details relating to PPA or energy credit sale, and any other pertinent information. The exchange service receives this composite bid and in turn transmits it to the property entity 102.

In other embodiments, each entity may place a separate bid for the property directly to the exchange service (i.e., skip block 160 entirely). In one example of such embodiments, the exchange service may determine a combination of the entities to present a composite bid to the property entity. The exchange service may use details or preferences provided by the property entity 102 to develop an optimal combination of the bids of the entities for submission as a composite bid to the property entity 102. In other examples of this embodiment, the exchange service may directly transmit the individual bids to the property entity 102 to allow the property entity to determine a suitable combination of the entities based on the property entity's preferences. It is understood that other combinations or iterations of bid-placements or bid-combinations, as may be envisioned by a person of ordinary skill in the art, may be used in lieu of the above illustrated examples. Once a property entity 102 selects or accepts a particular combination of bids places by the entities, the exchange service receives the choice from the property entity and transmits the choice to the respective entities. This allows the entities to eventually install and operate the solar energy setup at the asset indicated by the property owner.

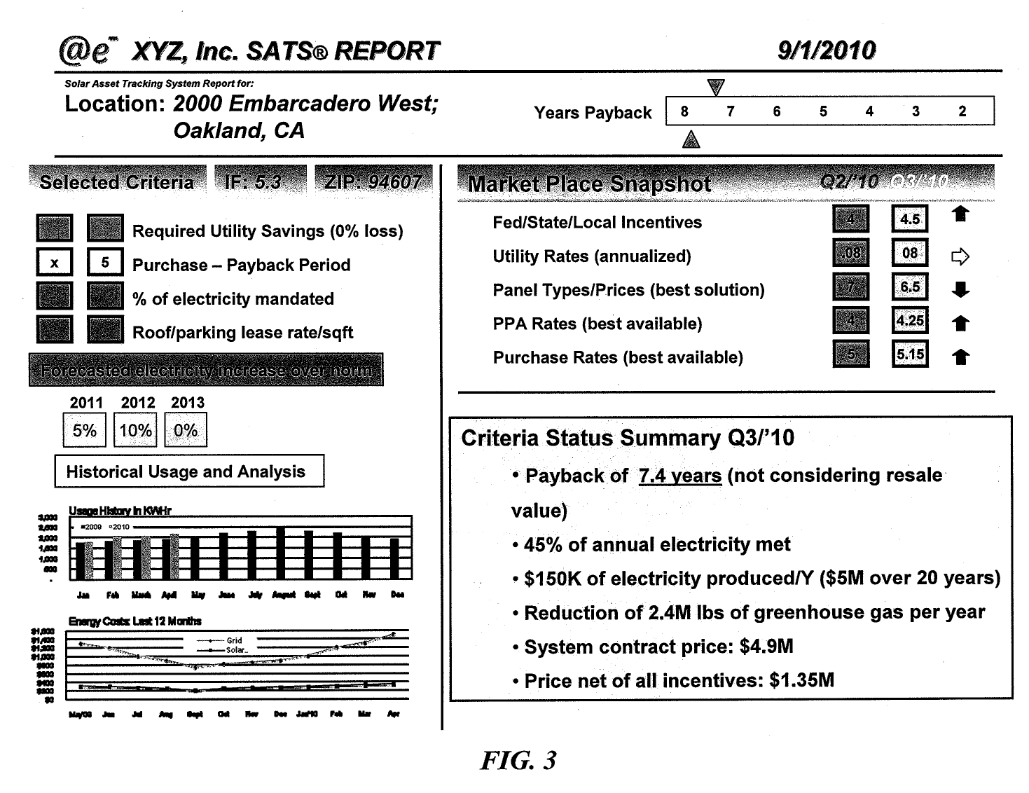

In addition to offering a marketplace for the purpose of enabling placement of assets and inviting and processing bids for the place, the exchange service also offers post-installation services to the property entity 102 and other entities. An example of such a post-installation service is described with reference to FIG. 3. FIG. 3 illustrates a post-installation user dashboard offered by the exchange service. Using a dashboard service (not shown in FIG. 3), the exchange service offers a variety of services to enable the property entity 102 to track various details related to the installation and operation of the energy setup. The dashboard service uses information provided by the various entities to culminate, process, and present the information to the property entity upon demand. As illustrated in FIG. 3, this includes, for example, electricity usage and savings over a given period of time, PPA financial analysis, market place snapshots, utility dates, tracking various parameters like incentives, percentage-to-target energy development, etc. Of course, it is understood that FIG. 3 provides one possible implementation of a dashboard presented to a user, and other information or presentation formats, as understood by one ordinary skill in the art, are equally effective as alternate embodiments.

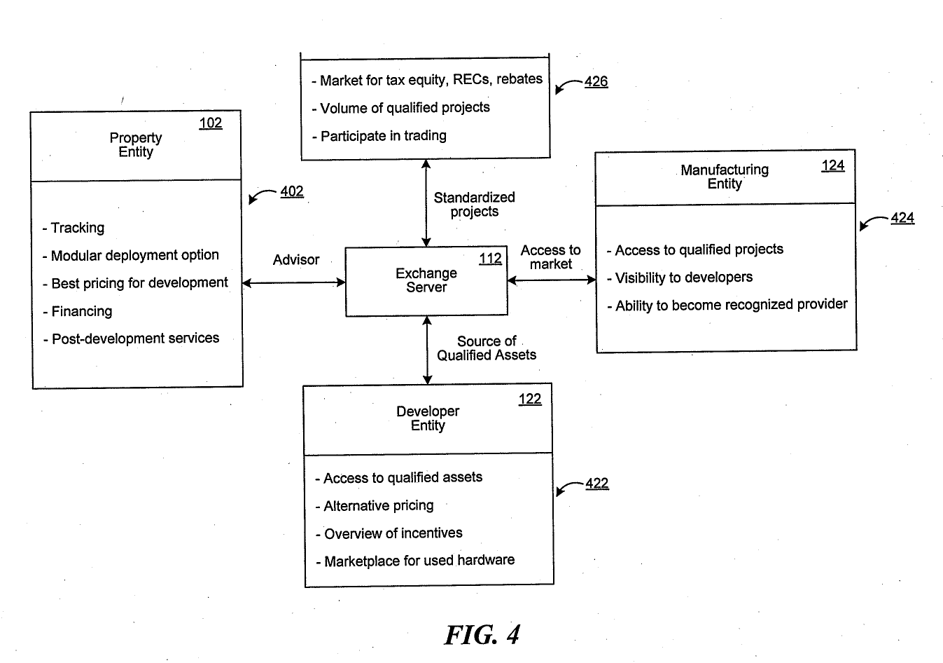

FIG. 4 provides a quick snapshot of the various roles played by the exchange service (implemented on the exchange server 112) to each of the entities. For example, the exchange service functions as an advisor to a property entity 102, offering such services as placing and tracking assets on the marketplace, providing options for modular deployment of energy installation, providing best prices for development, providing best composite bid combinations, providing financing details and options, providing post-development services, etc. Further, for example, the exchange service functions as a source of qualified roofs to a developer entity 122, providing such services as access to qualified assets, providing alternative pricing options, providing an overview of financing incentives, providing a marketplace for used solar energy hardware, etc. To the manufacturing entity 124, for example, the exchange service effectively functions as access to the solar energy development market by providing services such as access to qualified projects, visibility to developers, providing an ability to become a recognized provider of solar energy parts, etc. Also, for example, the exchange service operates effectively as a source of standardized projects to the financial entity 126, providing services such as a market for tax equity, RECs, or rebates, providing a volume of qualified projects, providing capabilities to participate in trading, etc. Of course, these services detailed here are intended to be exemplary of the services offered by the exchange service, and is not a comprehensive list.

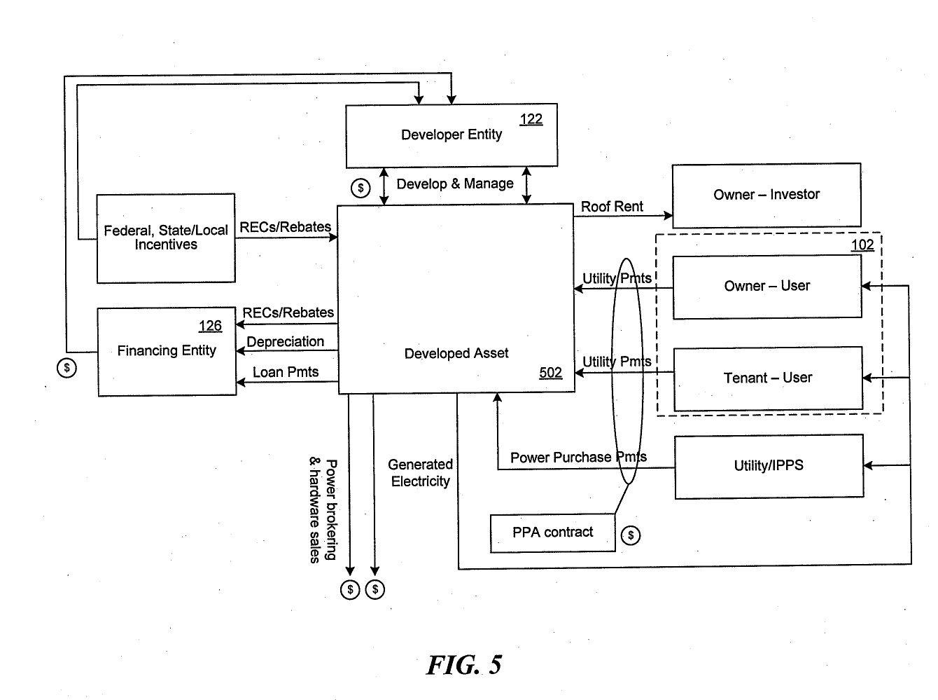

FIG. 5 is a block diagram illustrating the business aspects and monetary gains associated with the exchange server entity 112 in return for offering the exchange service. Block 502 represents a developed solar energy setup at an asset associated with a property entity, where the development was a result of the initial exchange of bids using the marketplace offered by the exchange service. The developer entity 122 is primarily responsible for the development and management of the asset 502, using, for example, manufacturing parts provided and/or serviced by the manufacturing entity 124 and financing provided by the financing entity 126. The property entity 102 purchases the power generated from the developed asset, and in turn makes utility payments to the developer entity 122. The developer entity 122 may also sell excess power generated from the developed asset to utility or IPPS (or other such) companies, and receive power purchase payments from such companies in return. The developer entity earns or receives RECs and rebates (e.g., as part of government incentives) as a result of the developed asset. The developer entity shares or remits this to the financing entity 126 per a prearranged agreement, if any. The financing entity also receives depreciation cost and loan repayments from the developer entity. In some instances, after completion of a contract, the developer entity (in some instances, in association with the manufacturer entity) offers the used hardware for resale (using, for example, resale services offered by the exchange service as explained above).

The following section describes the various financial incentives that may result from the operation of the exchange service. In one example, the exchange service charges a commission of a percentage of the developed asset 502 value. In another example, the exchange service charges the financing entity 126 a certain percentage on some or all financing packages (including, for example, RECs/rebates, depreciation credit, loan repayments from developer, etc.). In another example, the exchange service charges a certain percentage of all utility or PPA payments paid by the property owner over the duration of the contract with the developer. In one example, the exchange service may charge the manufacturing entity or the developer entity a certain percentage of transaction value based on resale of used equipment. It is understood that this list may further include other similar financial incentives or commissions as may be envisioned by one of ordinary skill in the art.

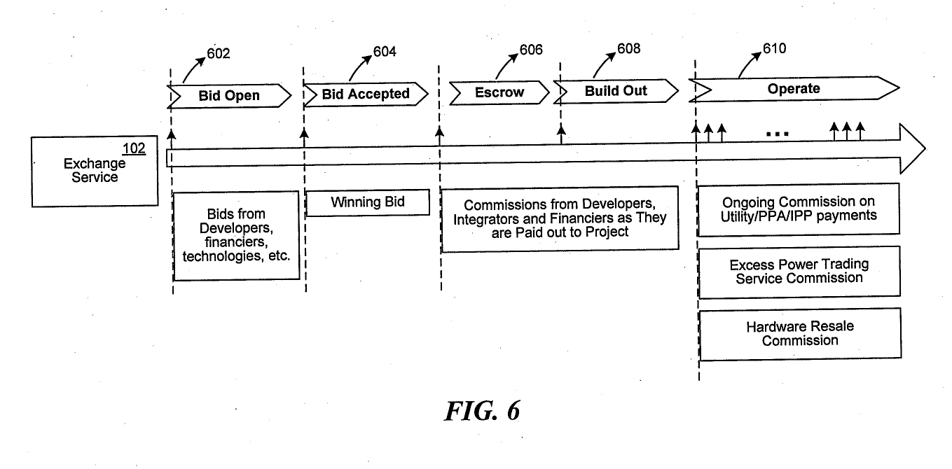

FIG. 6 is a simplified flow diagram providing a summary of the overall services offered with respect to the exchange service. A first phase of the services offered through the exchange service is the “bid open” phase 602, where assets are placed in the marketplace and bids are invited from developers, financiers, technology manufacturers, etc. In a second phase 604, bids are accepted and communicated to the pertinent parties, which spurs the development of the solar energy setup at the asset location. The third and the fourth phases (606 and 608), the escrow and build out phases, are related to the commissioning and development of the solar energy setup. At this stage, for example, the exchange service derives financial benefits from the developers and the financiers commensurate to the value of the developed asset. The final phase, the operate, phase 610, relates to the generation and supply of energy through the completion of the contract requirements. In this phase, the exchange service potentially derives several financial benefits, including, for example, outgoing commission on utility, PPA, or IPP payments, excess power trading service commissions, hardware resale commissions, etc.

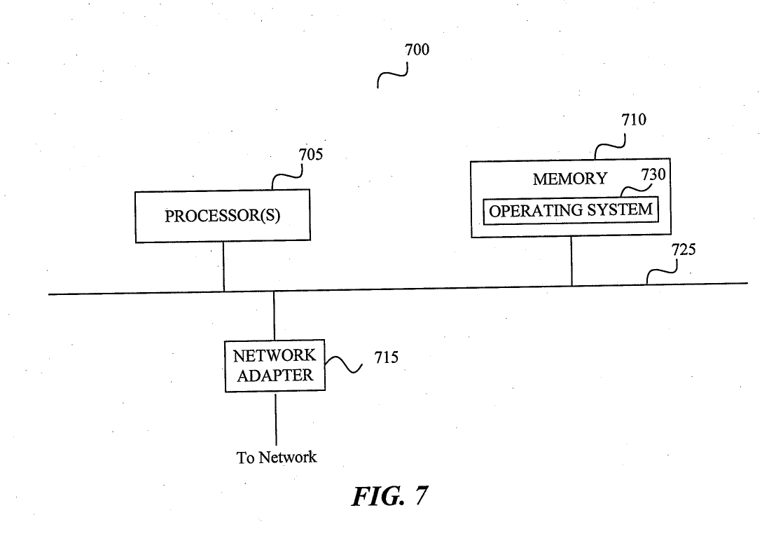

FIG. 7 is a high-level block diagram showing an example of the architecture for a computer system 600 that can be utilized to implement the exchange entity server 102, servers of computers associated with the developer. entity 122, the manufacturer entity 124, financial entity 126, etc. In FIG. 7, the computer system 700 includes one or more processors 705 and memory 710 connected via an interconnect 725. The interconnect 725 is an abstraction that represents any one or more separate physical buses, point to point connections, or both connected by appropriate bridges, adapters, or controllers. The interconnect 725, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Firewire”.

The processor(s) 705 may include central processing units (CPUs) to control the overall operation of, for example, the host computer. In certain embodiments, the processor(s) 705 accomplish this by executing software or firmware stored in memory 710. The processor(s) 705 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 710 is or includes the main memory of the computer system 1100. The memory 710 represents any form of random access memory (RAM), read-only memory (ROM), flash memory (as discussed above), or the like, or a combination of such devices. In use, the memory 710 may contain, among other things, a set of machine instructions which, when executed by processor 705, causes the processor 705 to perform operations to implement embodiments of the present invention.

Also connected to the processor(s) 705 through the interconnect 725 is a network adapter 715. The network adapter 715 provides the computer system 600 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A method for operating a marketplace and an exchange service for renewable energy resources, the method comprising:
receiving, by an exchange server implementing the exchange service, a property owner's input associated with an asset available to host a renewable energy setup; and
placing, by the exchange server, the asset in an exchange market operated by the exchange server, wherein the exchange market is accessible by a plurality of resource providers, and wherein the exchange market enables each of the plurality of resource providers to perform transactions for the purpose of establishing the renewable energy setup at a location of the asset indicated by the property owner.

2. The method of claim 1, further comprising:
prior to placing the asset in the exchange market, analyzing the input associated with the asset to determine whether the asset qualifies for installation of the renewable energy setup.

3. The method of claim 1, wherein the renewable energy setup is one or more of:
a solar energy setup;
a geothermal energy setup;
a wind energy setup; or
a tidal energy setup.

4. The method of claim 1, wherein the property owner's input associated with the asset includes one or more of:
a property location;
a dimensional area of the asset;
an unusable area of the asset with respect to an installation of the renewable energy setup;
a desired requirement of the property owner in having the renewable energy setup installed;
a current power usage pattern related to the property; or
a current energy payment related to the property.

5. The method of claim 1, wherein the plurality of resource providers further includes:
a first subplurality of energy developers;
a second subplurality of energy equipment manufacturers; and
a third subplurality of energy setup financiers.

6. The method of claim 5, further comprising:
receiving, by the exchange server, a plurality of bids from the plurality of resource providers to establish the renewable energy setup at the location of the asset.

7. The method of claim 6, wherein a given bid of the plurality of bids is placed collectively by a particular combination of one or more of a given energy developer, a given energy equipment manufacturer, or a given energy setup financier, and wherein the exchange service transmits the given bid as a composite bid to the property owner.

8. The method of claim 6, wherein a given bid of the plurality of bids is placed individually by one of an energy developer, an energy equipment manufacturer, or an energy setup financier.

9. The method of claim 8, further comprising:
selecting, via the exchange server, a particular combination of bids from one or more of a given energy developer, a given energy equipment manufacturer, or a given energy setup financier, wherein the exchange server transmits the particular combination as a final bid to the property owner.

10. The method of claim 6, further comprising:
enabling, by the exchange server, each of the plurality of resource providers to form an alliance with a given subplurality of the plurality of resource providers for establishing the renewable energy setup, wherein the exchange server transmits a combination of a given plurality of bids placed by each of the resource providers of the alliance as a composite bid to the property owner.

11. The method of claim 6, further comprising:
transmitting one or more composite bids to the property owner based on the plurality of bids received from the plurality of resource providers;
receiving a selection of a successful bid from the property owner; and
communicating the selection to one or more resource providers associated with the successful bid.

12. The method of claim 11, further comprising:
receiving, by the exchange service, a monetary commission from the one or more resource providers associated with the successful bid.

13. The method of claim 12, wherein the monetary commission from the one or more resource providers includes one or more of:
a first one-time commission from a winning energy developer in response to securing the successful bid;
a second one-time commission from a winning energy equipment manufacturer in response to securing the successful bid;
a third one-time commission from a winning energy setup financier in response to securing the successful bid;
a first ongoing commission on utility payments received by the winning energy developer;
a second ongoing commission on PPA payments received by the winning energy developer;
a third ongoing commission on IPP payments received by the winning energy developer;
a hardware resale commission; or
an excess power trading service commission.

14. A method for operating a marketplace and an exchange service for renewable energy resources, the method comprising:
maintaining, by an exchange server implementing the exchange service, a database of pre-approved assets, each asset associated with a property available for installation of a renewable energy setup;
operating, by the exchange server, a marketplace, the marketplace allowing a plurality of renewable service providers to place a bid to acquire rights to install a particular renewable energy setup at a selected one of the pre-approved assets;
receiving, by the exchange server, one or more bids from the plurality of renewable energy service providers for a specific pre-approved asset; and
transmitting, by the exchange server, the one or more bids to a property owner associated with the specific pre-approved asset.

15. The method of claim 14, further comprising:
receiving, by the exchange server, a property owner's selection of a final bid from the one or more bids; and
transmitting, by the exchange server, an indication of the selection to one or more renewable energy service providers associated with the final bid.

16. The method of claim 14, wherein the renewable energy setup is one or more of:
a solar energy setup;
a geothermal energy setup;
a wind energy setup; or
a tidal energy setup.

17. The method of claim 14, wherein the plurality of resource providers further includes:
a first subplurality of energy developers;
a second subplurality of energy equipment manufacturers; and
a third subplurality of energy setup financiers.

18. The method of claim 14, further comprising:
establishing, by the exchange server, a dashboard for a property owner to track details related to the renewable energy setup subsequent to a completed installation of the renewable energy setup.

19. The method of claim 14, further comprising:
establishing, by the exchange server, a second marketplace for sale of excess power generated by a particular renewable energy setup installed at a given asset.

20. The method of claim 14, further comprising:
establishing, by the exchange server, a third marketplace for hardware resale related to a particular renewable energy setup installed at a given asset.

21. A system for implementing a marketplace and an exchange service for renewable energy resources, the system comprising:
a processor;
a memory configured to store a set of instructions, which when executed by the processor cause the system to perform a method, the method including:
receiving, by an exchange server implementing the exchange service, a property owner's input associated with an asset available to host a renewable energy setup; and
placing, by the exchange server, the asset in an exchange market operated by the exchange server, wherein the exchange market is accessible by a plurality of resource providers, and wherein the exchange market enables each of the plurality of resource providers to perform transactions for the purpose of establishing the renewable energy setup at a location of the asset indicated by the property owner.

22. The system of claim 21, wherein the method further comprises:
prior to placing the asset in the exchange market, analyzing the input associated with the asset to determine whether the asset qualifies for installation of the renewable energy setup.

23. The system of claim 21, wherein the renewable energy setup is one or more of:
a solar energy setup;
a geothermal energy setup;
a wind energy setup; or
a tidal energy setup.

24. The system of claim 21, wherein the property owner's input associated with the asset includes one or more of:
a property location;
a dimensional area of the asset;
an unusable area of the asset with respect to an installation of the renewable energy setup;
a desired requirement of the property owner in having the renewable energy setup installed;
a current power usage pattern related to the property; or
a current energy payment related to the property.

25. The system of claim 21, wherein the plurality of resource providers further includes:
a first subplurality of energy developers;
a second subplurality of energy equipment manufacturers; and
a third subplurality of energy setup financiers.

26. The system of claim 25, wherein the method further comprises:
receiving, by the exchange server, a plurality of bids from the plurality of resource providers to establish the renewable energy setup at the location of the asset.

27. The system of claim 26, wherein a given bid of the plurality of bids is placed collectively by a particular combination of a given energy developer, a given energy equipment manufacturer, and a given energy setup financier, and wherein the exchange service transmits the given bid as a final bid to the property owner.

28. The system of claim 26, wherein a given bid of the plurality of bids is placed individually by one of an energy developer, an energy equipment manufacturer, or an energy setup financier.

29. The system of claim 28, wherein the method further comprises:
selecting, via the exchange server, a particular combination of bids from one or more of a given energy developer, a given energy equipment manufacturer, and a given energy setup financier, wherein the exchange server transmits the particular combination as a composite bid to the property owner.

30. The system of claim 26, wherein the method further comprises:
enabling, by the exchange server, each of the plurality of resource providers to form an alliance with a given subplurality of the plurality of resource providers for establishing the renewable energy setup, wherein the exchange server transmits a combination of a given plurality of bids placed by each of the resource providers of the alliance as a composite bid to the property owner.

31. The system of claim 26, wherein the method further comprises:
transmitting one or more composite bids to the property owner based on the plurality of bids received from the plurality of resource providers;
receiving a selection of a successful bid from the property owner; and
communicating the selection to one or more resource providers associated with the successful bid.

32. The system of claim 31, wherein the method further comprises:
receiving, by the exchange service, a monetary commission from the one or more resource providers associated with the successful bid.

33. The system of claim 32, wherein the monetary commission from the one or more resource providers includes one or more of:
a first one-time commission from a winning energy developer in response to securing the successful bid;
a second one-time commission from a winning energy equipment manufacturer in response to securing the successful bid;
a third one-time commission from a winning energy setup financier in response to securing the successful bid;
a first ongoing commission on utility payments received by the winning energy developer;
a second ongoing commission on PPA payments received by the winning energy developer;
a third ongoing commission on IPP payments received by the winning energy developer;
a hardware resale commission; or
an excess power trading service commission.

34. A system for implementing a marketplace and an exchange service for renewable energy resources, the system comprising:
a processor;
a memory configured to store a set of instructions, which when executed by the processor cause the system to perform a method, the method including:
maintaining, by an exchange server implementing the exchange service, a database of pre-approved assets, each asset associated with a property asset available for installation of a renewable energy setup;
operating, by the exchange server, a marketplace, the marketplace allowing a plurality of renewable service providers to place a bid to acquire rights to install a particular renewable energy setup at a selected one of the pre-approved assets;
receiving, by the exchange server, one or more bids from the plurality of renewable energy service providers for a specific pre-approved asset; and
transmitting, by the exchange server, the one or more bids to a property owner associated with the specific pre-approved asset.

35. The system of claim 34, wherein the method further comprises:
receiving, by the exchange server, a property owner's selection of a final bid from the one or more bids; and
transmitting, by the exchange server, an indication of the selection to one or more renewable energy service providers associated with the final bid.

36. The system of claim 34, wherein the renewable energy setup is one or more of:
a solar energy setup;
a geothermal energy setup;
a wind energy setup; or
a tidal energy setup.

37. The system of claim 34, wherein the plurality of resource providers further includes:
a first subplurality of energy developers;
a second subplurality of energy equipment manufacturers; and
a third subplurality of energy setup financiers.

38. The system of claim 34, wherein the method further comprises:
establishing, by the exchange server, a dashboard for a property owner to track details related to the renewable energy setup subsequent to a completed installation of the renewable energy setup.

39. The system of claim 34, wherein the method further comprises:
establishing, by the exchange server, a second marketplace for sale of excess power generated by a particular renewable energy setup installed at a given asset.

40. The system of claim 34, wherein the method further comprises:
establishing, by the exchange server, a third marketplace for hardware resale related to a particular renewable energy setup installed at a given asset.
